(19) United States
(12) Patent Application Publication
(10) Pub. No.: US 2017/0022892 A1
(43) Pub. Date: Jan. 26, 2017

(54) CONTROL APPARATUS OF ENGINE

(71) Applicant: Mazda Motor Corporation, Hiroshima (JP)

(72) Inventors: Masahiko Fujimoto, Hiroshima-shi (JP); Hiroyuki Yamashita, Hiroshima-shi (JP); Keiji Araki, Hatsukaichi-shi (JP)

(21) Appl. No.: 15/213,729

(22) Filed: Jul. 19, 2016

(30) Foreign Application Priority Data
Jul. 22, 2015 (JP) 2015-144785

(51) Int. Cl. F02B 47/02; F01N 3/02; F02D 41/10

(52) U.S. Cl. CPC F02B 47/02; F02D 41/10; F01N 3/02; F01N 2570/22; F01N 2240/02

(57) ABSTRACT

A control apparatus of an engine including a cylinder into which a piston is reciprocatably fitted is provided. The apparatus includes a fuel injector for injecting fuel into the cylinder, a water injector for injecting supercritical or subcritical water into the cylinder, and a controller. The controller includes an operating range determining module for receiving a parameter and determining whether an engine operating range is within a water injection range. Within the water injection range, the controller controls the fuel injector to inject a portion of the fuel on an intake stroke or in an early half of compression stroke, and the water injector to inject the water toward a piston crown surface in a period that is between a latter half of the compression stroke and an early half of expansion stroke, after the fuel injection, and before a mixture gas is ignited inside the cylinder.

### BACKGROUND

The present invention relates to a control apparatus of an engine having a cylinder into which a piston is reciprocatably fitted.

Conventionally, in order to improve fuel consumption of an engine, it is desireable to reduce a loss in the engine caused by release of thermal energy of combustion gas from a wall surface of a combustion chamber to an outside of the engine, in other words, a cooling loss.

In this regard, for example, JP2013-194622A discloses an engine in which an air layer is formed around an outer circumferential section of a combustion chamber by causing fuel to stagnate within a center section of the combustion chamber, so as to reduce by the air layer release of thermal energy of combustion gas to an outside of the engine.

According to the engine of JP2013-194622A, a cooling loss can be reduced and fuel consumption can be improved. However, with the engine, since the fuel concentrates within the center section of the combustion chamber, a rich mixture gas (a mixture gas in which a ratio of the fuel is large) is easily formed locally within the combustion chamber. Therefore, suitable combustion is not performed within the combustion chamber and production of smoke etc. may increase.

### SUMMARY

The present invention is made in view of the above situations and aims to provide a control apparatus of an engine, which is capable of achieving suitable combustion more reliably while reducing a cooling loss.

According to one aspect of the present invention, a control apparatus of an engine including an engine body and a cylinder into which a piston is reciprocatably fitted is provided. The apparatus includes a fuel injector for injecting fuel into the cylinder, a water injector for injecting one of supercritical water and subcritical water into the cylinder, and a controller for controlling various parts of the engine, the various parts including the fuel injector and the water injector. The water injector is attached to a predetermined position of the engine body to be capable of injecting the one of the supercritical water and the subcritical water toward a crown surface of the piston. The controller includes an operating range determining module for receiving at least a parameter that varies based on an accelerator opening, and determining whether a current operating range of the engine body is within a water injection range set as at least one of operating ranges of the engine body. When the current operating range of the engine body is determined to be within the water injection range by the operating range determining module, the controller outputs a control signal to the fuel injector to inject at least a portion of the fuel into the cylinder at one of on intake stroke and in an early half of compression stroke, and the controller outputs a control signal to the water injector to inject the one of the supercritical water and the subcritical water toward the crown surface of the piston in a period between a latter half of the compression stroke and an early half of expansion stroke, the period being after the fuel injection is completed by the fuel injector and before a mixture gas containing the fuel and air is ignited inside the cylinder.

According to this configuration, by injecting the fuel into a combustion chamber (cylinder) of the engine at a comparatively early timing which is one of on the intake stroke and in the early half of the compression stroke, the fuel can be sufficiently mixed with air before the ignition of the mixture gas. Additionally, by injecting the water toward the piston crown surface before the ignition, the water can be attached to the piston crown surface (i.e., one of wall surfaces of the combustion chamber) to form a heat insulating layer with the water before the ignition. Therefore, a cooling loss can be reduced while combusting the mixture gas in a homogenized state to achieve suitable combustion.

Particularly in the above configuration, the one of the supercritical water and the subcritical water which has a higher density than water in a normal gas phase is used as the water, and this supercritical water etc. is injected into the cylinder when a temperature and pressure in the cylinder are high, which is between the latter half of the compression stroke and the early half of the expansion stroke, so that the water remains on the wall surface of the combustion chamber in a state of the one of the supercritical water and the subcritical water. Therefore, a high heat insulating effect can be obtained by increasing the density of the water of the heat insulating layer. As a result, the cooling loss can be reduced more reliably and fuel consumption can be improved.

Note that, in the present invention, the early half of the compression stroke is a period between a bottom dead center of the intake stroke and 90° CA (crank angle) before a top dead center of the compression stroke (CTDC), the latter half of the compression stroke is a period between 90° CA before CTDC and the CTDC, and the early half of the expansion stroke is a period between the CTDC and 90° CA after the CTDC.

According to another aspect of the present invention, a control apparatus of an engine including an engine body, a cylinder into which a piston is reciprocatably fitted, and an intake port for introducing air into the cylinder, is provided. The apparatus includes a fuel supplier for injecting fuel into the intake port, a water injector provided to the cylinder and for injecting one of supercritical water and subcritical water into the cylinder, and a controller for controlling various parts of the engine, the various parts including the fuel supplier and the water injector. The water injector is attached to a predetermined position of the engine body to be capable of injecting the one of the supercritical water and the subcritical water toward a crown surface of the piston. The controller includes an operating range determining module for receiving at least a parameter that varies based on an accelerator opening, and determining whether a current operating range of the engine body is within a water injection range set as at least one of operating ranges of the engine body. When the current operating range of the engine body is determined to be within the water injection range by the operating range determining module, the controller outputs a control signal to the water injector to inject the one of the supercritical water and the subcritical water toward the crown surface of the piston in a period between the latter half of compression stroke and the early half of expansion stroke, the period being before the mixture gas containing air and the fuel that is introduced into the cylinder through the intake port by the fuel supplier is ignited.

Also in this apparatus, while homogenizing the mixture gas within the combustion chamber of the engine before the ignition by supplying the fuel into the intake port, the layer of the one of the supercritical water and the subcritical water is formed on one of wall surfaces of the combustion chamber by injecting the one of the supercritical water and the subcritical water. Therefore, a cooling loss can be reduced while achieving the suitable combustion.

In the above configurations, the water injection range may be a range where a load of the engine is a predetermined reference load or above.

Thus, the cooling loss which easily increases as the engine load increases and a combustion temperature increases can effectively be reduced.

In the above configurations, a geometric compression ratio of the engine body may be set to be between 18:1 and 35:1. An effective compression ratio of the engine body within the water injection range may be set to be between 15:1 and 30:1.

Thus, the effective compression ratio can be increased to increase an engine torque while reducing the cooling loss which easily increases due to the large effective compression ratio.

The control apparatus may further include a water processing device for generating the one of the supercritical water and the subcritical water. The water processing device may include a condenser for condensing water vapor contained within exhaust gas discharged from the engine body, and a heater and compressor for increasing the condensed water vapor in temperature and pressure by supplying thermal energy of the exhaust gas to the condensed water vapor.

### BRIEF DESCRIPTION OF THE DRAWINGS

FIG. 1 is a view illustrating a configuration of an engine system according to a first embodiment of the present invention.

FIG. 2 is a water phase diagram illustrating supercritical water.

FIG. 3 is a water phase diagram illustrating subcritical water.

FIG. 4 is an enlarged cross-sectional view schematically illustrating a part of an engine body according to the first embodiment.

FIG. 5 is a cross-sectional view schematically illustrating a fuel injector.

FIG. 6 is a block diagram illustrating a control system of the engine.

FIG. 7 is a chart illustrating a control range of the engine.

FIG. 8 shows charts illustrating a heat release rate, a fuel injection ratio, and a water injection ratio, respectively, within a high engine load range.

FIG. 9 is a view illustrating a state where a heat insulating layer is formed by supercritical water.

FIG. 10 is an enlarged cross-sectional view schematically illustrating a part of an engine body according to a second embodiment.

### DETAILED DESCRIPTION OF EMBODIMENTS

### (1) Overall Configuration of Engine System

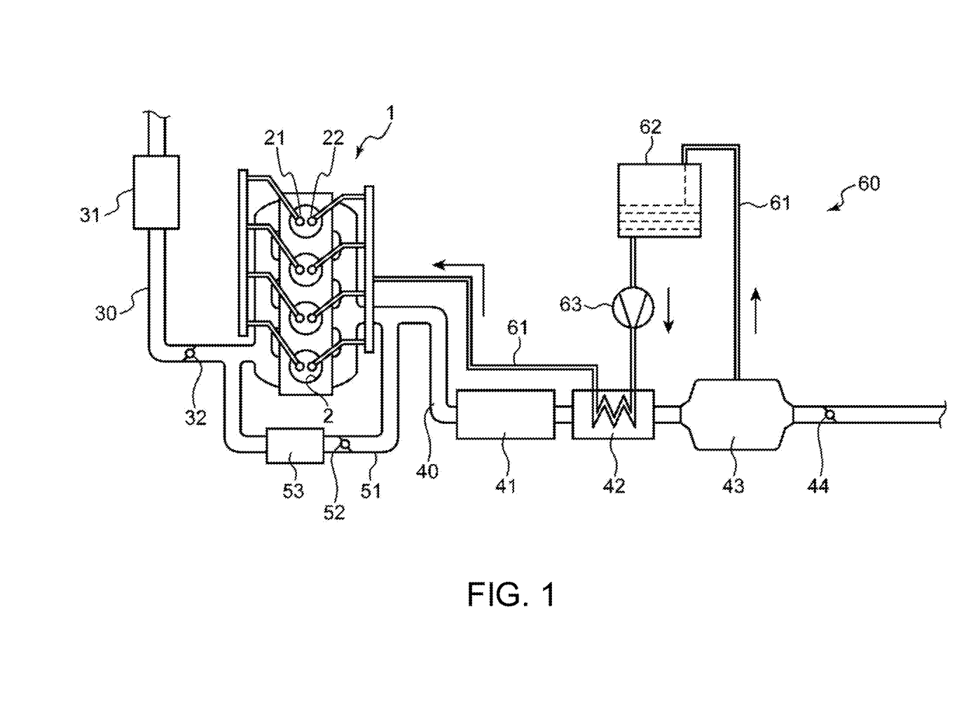

FIG. 1 is a view illustrating a configuration of an engine system to which a control apparatus of an engine is applied, according to a first embodiment of the present invention. The engine system of this embodiment includes an engine body 1 of a four stroke type, an intake passage 30 for introducing air for combustion into the engine body 1, and an exhaust passage 40 for discharging exhaust gas generated in the engine body 1. The engine body 1 is, for example, a four-cylinder engine having four cylinders 2. Although the kind of fuel which is supplied to the engine body 1 is not limited, in this embodiment, fuel containing gasoline is used. The engine system of this embodiment is mounted on a vehicle, and the engine body 1 is used as a drive source of the vehicle.

The intake passage 30 is provided with, in the following order from its upstream side, an air cleaner 31 and a throttle valve 32. The air passes through the air cleaner 31 and the throttle valve 32 and then is introduced into the engine body 1.

The throttle valve 32 opens and closes the intake passage 30. Note that, in this embodiment, while the engine is in operation, the throttle valve 32 is basically kept fully opened or nearly fully opened, and only in a limited operation condition (e.g., the engine is stopped) is the throttle valve 32 closed to block the intake passage 30.

The exhaust passage 40 is provided with, in the following order from its upstream side, a three-way catalyst 41 for purifying the exhaust gas, a heat exchanger 42 (a heater and a compressor), a condenser 43, and an exhaust shutter valve 44. The heat exchanger 42 and the condenser 43 constitute a part of a later-described exhaust heat recovery device 60 (a water processing device).

The exhaust shutter valve 44 stimulates a recirculation of an Exhaust Gas Recirculation (EGR) gas to the intake passage 30.

Specifically, with the engine system of this embodiment, an EGR passage 51 communicating a part of the intake passage 30 downstream of the throttle valve 32 with a part of the exhaust passage 40 upstream of the three-way catalyst 41 is formed, and a portion of the exhaust gas is recirculated as the EGR gas to the intake passage 30. Further, the exhaust shutter valve 44 opens and closes the exhaust passage 40. When the EGR is performed and pressure inside the exhaust passage 40 is low, an opening of the exhaust shutter valve 44 is narrowed to increase pressure inside an upstream part of the EGR passage 51 so as to stimulate the EGR gas recirculation.

The EGR passage 51 is provided with an EGR valve 52 for opening and closing the EGR passage 51, and an amount of the EGR gas recirculated to the intake passage 30 is controlled by adjusting an opening of the EGR valve 52. Further in this embodiment, the EGR passage 51 is provided with an EGR cooler 53 for cooling the EGR gas passing therethrough, and the EGR gas is recirculated to the intake passage 30 after being cooled by the EGR cooler 53.

The exhaust heat recovery device 60 generates supercritical water by using thermal energy of the exhaust gas. Specifically, with the engine system of this embodiment, the supercritical water is injected into the respective cylinders 2 from water injectors 22 as described later, and the supercritical water is generated by using the exhaust gas.

The exhaust heat recovery device 60 includes the heat exchanger 42 and the condenser 43, and additionally a condensed water passage 61, a water tank 62, and a water injection pump 63. The condensed water passage 61 connects the water injectors 22 with the condenser 43.

The condenser 43 condenses water (water vapor) within the exhaust gas passing through the exhaust passage 40. The water tank 62 stores the condensed water therein. The condensed water generated by the condenser 43 is introduced into the water tank 62 through the condensed water passage 61 and stored in the water tank 62.

The water injection pump 63 sends the condensed water inside the water tank 62 to the water injectors 22 through the heat exchanger 42. The condensed water inside the water tank 62 is increased in temperature and pressure by the water injection pump 63 when being sent. For example, the condensed water is increased to about 350 K in temperature and about 250 bar in pressure by the water injection pump 63.

The heat exchanger 42 exchanges heat between the condensed water sent by the water injection pump 63 and the exhaust gas passing through the exhaust passage 40. The heat exchanger 42 is an indirect heat exchanger, and the condensed water receives the thermal energy from the exhaust gas when passing through the heat exchanger 42. By passing through the heat exchanger 42, the condensed water is increased more in temperature and pressure from the state where pressure is applied thereto by the water injection pump 63, and becomes supercritical water.

The supercritical water is water at a higher temperature and pressure than at the critical point of water, and which has a high density close to a liquid while its molecules move as actively as a gas moves. In other words, the supercritical water is water which does not require latent heat for a phase change into gas or liquid. Although described later in detail, in this embodiment, by injecting the water with such properties into the cylinders 2, a heat insulating layer is formed on a wall surface of a combustion chamber 6 formed in each cylinder 2.

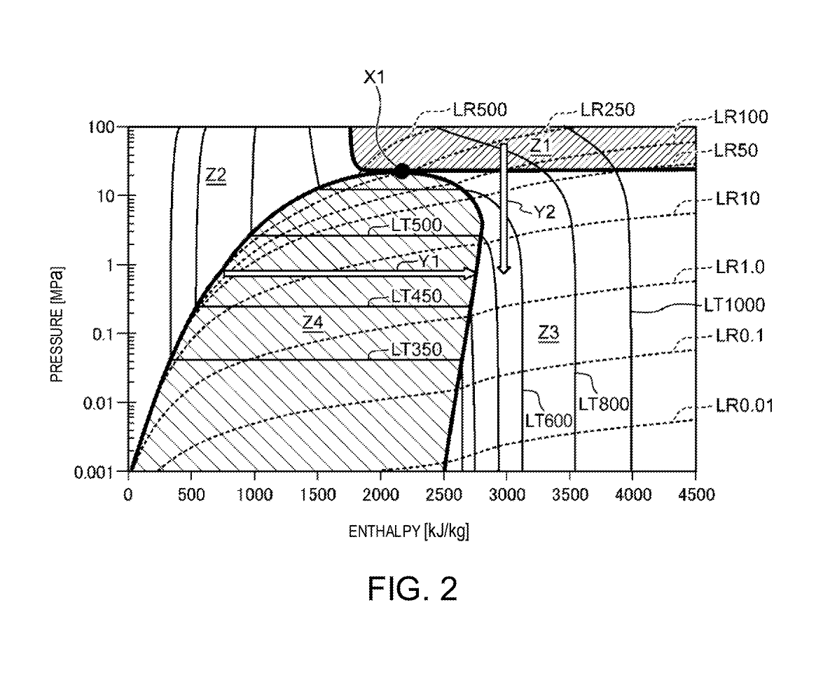

A specific description regarding this matter is given with reference to FIG. 2. FIG. 2 is a water phase diagram of which a horizontal axis indicates enthalpy and a vertical axis indicates pressure. In FIG. 2, an area Z2 is an area of liquid, an area Z3 is an area of gas, and an area Z4 is a coexisting area of liquid and gas. Lines LT350, LT400, . . . , LT1000 indicated by solid lines are isothermal lines, each formed by connecting points of the same temperature. The numbers of the lines indicate temperatures (K). For example, LT350 is an isothermal line of 350 K, and LT1000 is an isothermal line of 1,000 K. Further, a point X1 is the critical point and an area Z1 is an area where a temperature and pressure are higher than the critical point X1, and the supercritical water belongs to this area Z1. Specifically, while the critical point of water is at the temperature of 647.3 K and the pressure of 22.12 MPa, the temperature and pressure of the supercritical water are the same or above, in other words, the temperature is 647.3 K or above and the pressure is 22.12 MPa or above.

In FIG. 2, lines LR0.01, LR0.1, . . . , LR500 indicated by dashed lines are isopycnic lines, each formed by connecting points of the same density. The numbers of the lines indicate densities (kg/m³). For example, LR0.01 is an isopycnic line of 0.01 kg/m³, and LR500 is an isopycnic line of 500 kg/m³. As is apparent from comparisons of these isopycnic lines LR with the areas Z1 and Z3, the density of the water within the area Z1, in other words, the supercritical water, is about from 50 kg/m³ to 500 kg/m³, which is close to that of water in the liquid phase and much higher than a density of gas.

Note that the supercritical water generated by the engine system and injected into the cylinders 2 preferably has a density of 250 kg/m³ or above.

Further, as indicated by an arrow Y1 in FIG. 2, water in a normal liquid phase requires a high enthalpy to change into gas. In other words, the water in the normal liquid phase requires comparatively high latent heat to change into gas. In this regard, as indicated by an arrow Y2, the supercritical water requires almost no enthalpy, in other words, latent heat, to change into water in a normal gas phase.

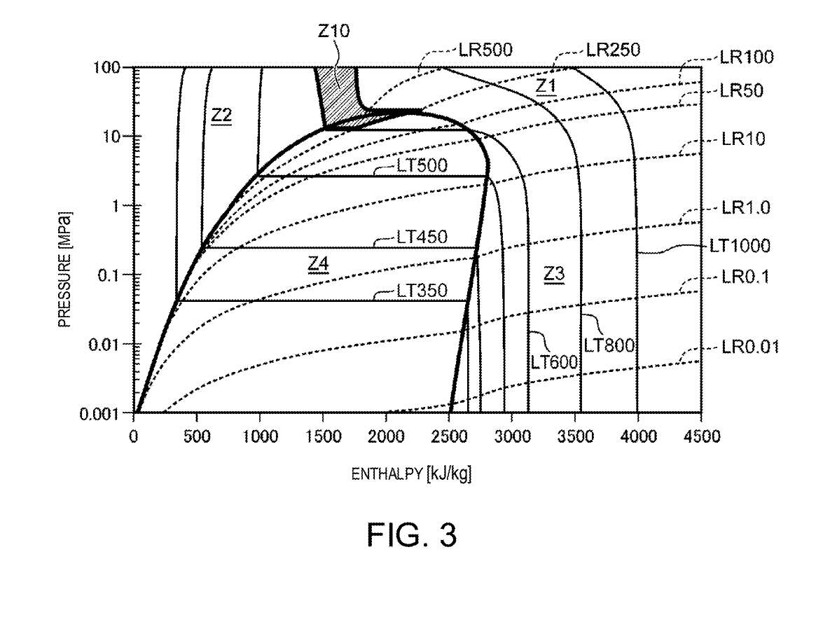

Here, as is apparent from FIG. 2, water belonging to an area near the area Z1 has a high density and requires low latent heat to change into gas, which are properties similar to the supercritical water. Therefore, although the supercritical water is generated by the exhaust heat recovery device 60 and injected into the cylinders 2 in this embodiment as described above, instead of the supercritical water, subcritical water which is water belonging to the area near the area Z1 may be generated and injected into the cylinders 2. For example, subcritical water within an area Z10 where the temperature is 600 K or above and the density is 250 kg/m³ or above (see FIG. 3) may be generated and injected.

### (2) Structure of Engine Body

A structure of the engine body 1 is described next.

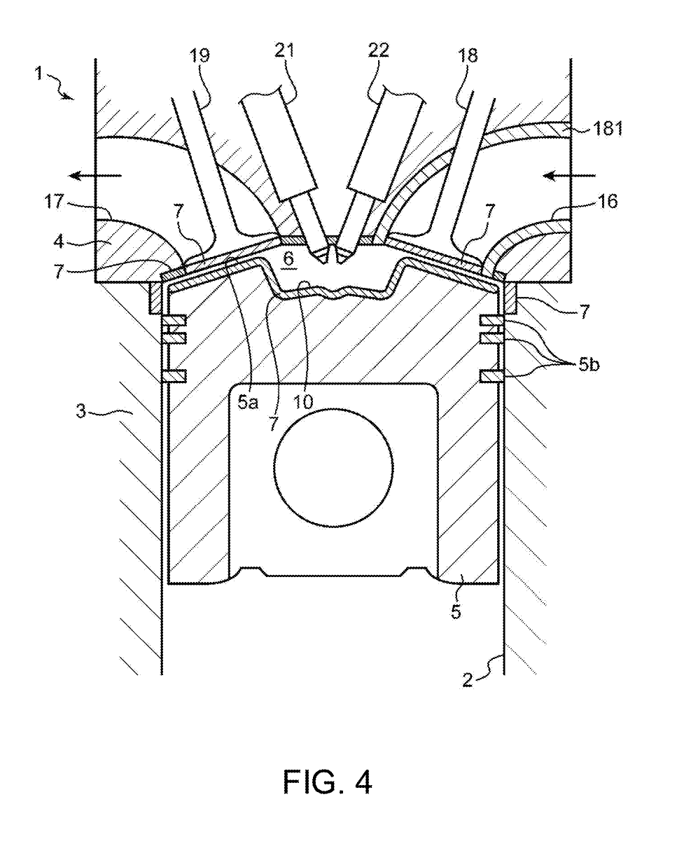

FIG. 4 is an enlarged cross-sectional view illustrating a part of the engine body 1. As illustrated in FIG. 4, the engine body 1 includes a cylinder block 3 formed therein with the cylinders 2, a cylinder head 4 formed on the cylinder block 3, and pistons 5 fitted into the cylinders 2 to be reciprocatable (in up-and-down directions), respectively.

The combustion chamber 6 is formed above each piston 5. The combustion chamber 6 is a so-called pent-roof type, and a ceiling surface of the combustion chamber 6 (a bottom surface of the cylinder head 4) has a triangular roof shape formed by two inclining surfaces on an intake side and an exhaust side.

In this embodiment, to reduce a cooling loss by reducing release of heat of the combustion gas from the combustion chamber 6 to the outside of the combustion chamber 6, wall surfaces (inner surfaces) of each combustion chamber 6 are provided with heat insulating materials 7 having lower thermal conductivity than the inner surfaces of the combustion chamber 6. Specifically, the heat insulating material 7 is provided to each of a wall surface of the cylinder 2, a crown surface 5a of the piston 5, the bottom surface of the cylinder head 4, and surfaces of valve heads of intake and exhaust valves 18 and 19, which form the inner surfaces of the combustion chamber 6. Note that in this embodiment, as illustrated in FIG. 4, a position of the heat insulating material 7 provided on the wall surface of the cylinder 2 is limited to be higher (cylinder head 4 side) than piston rings 5b in a state where the piston 5 is at a top dead center (TDC), so that the piston rings 5b do not slide on the heat insulating material 7.

A specific material of the heat insulating material 7 is not limited as long as it has the low thermal conductivity as described above. However, the heat insulating material 7 is preferably made from a material having lower volumetric specific heat than the inner surfaces of the combustion chamber 6. Specifically, when the engine body 1 is cooled by a coolant, a gas temperature within the combustion chamber 6 varies as a combustion cycle progresses, whereas temperatures of the inner surfaces of the combustion chamber 6 are substantially fixed. Therefore, the cooling loss becomes large due to this temperature difference. For this reason, by making the heat insulating material 7 from a material having the low volumetric specific heat, the temperature of the heat insulating material 7 changes corresponding to the variation of the gas temperature within the combustion chamber 6, and as a result, the cooling loss can be reduced.

For example, the heat insulating materials 7 are formed by coating the inner surfaces of the combustion chamber 6 with a ceramic material (e.g., ZrO₂) in a manner using plasma thermal spraying. Note that the ceramic material may have multiple pores so that the thermal conductivity and volumetric specific heat of the heat insulating material 7 become even lower.

The crown surface 5a of each piston 5 has a cavity 10 formed by denting to an opposite side from the cylinder head 4 (downward) an area including a center of the crown surface 5a. The cavity 10 is formed to have a volume corresponding to a major part of the combustion chamber 6 when the piston 5 is at the TDC.

In this embodiment, a geometric compression ratio of the engine body 1, in other words, a ratio of a volume of the combustion chamber 6 when the piston 5 is at a bottom dead center (BDC) to a volume of the combustion chamber 6 when the piston 5 is at the TDC is set to be between 18:1 and 35:1 (e.g., about 20:1).

The cylinder head 4 is formed with intake ports 16 for introducing air (fresh air and, depending on an operating state of the engine, the EGR gas) supplied from the intake passage 30 into the respective combustion chambers 6, and exhaust ports 17 for guiding out the exhaust gas generated within the respective combustion chambers 6 to the exhaust passage 40, respectively. The cylinder head 4 is further provided with the intake valves 18 for opening and closing the respective intake ports 16 on the combustion chamber 6 side, and the exhaust valves 19 for opening and closing the respective exhaust ports 17 on the combustion chamber 6 side, respectively. In this embodiment, one intake port 16 and one exhaust port 17 are formed for each cylinder 2, and one intake valve 18 and one exhaust valve 19 are provided for each cylinder 2. Note that, in the example of FIG. 4, an inner surface of each intake port 16 is also formed with a heat insulating layer 181 of the heat insulating material.

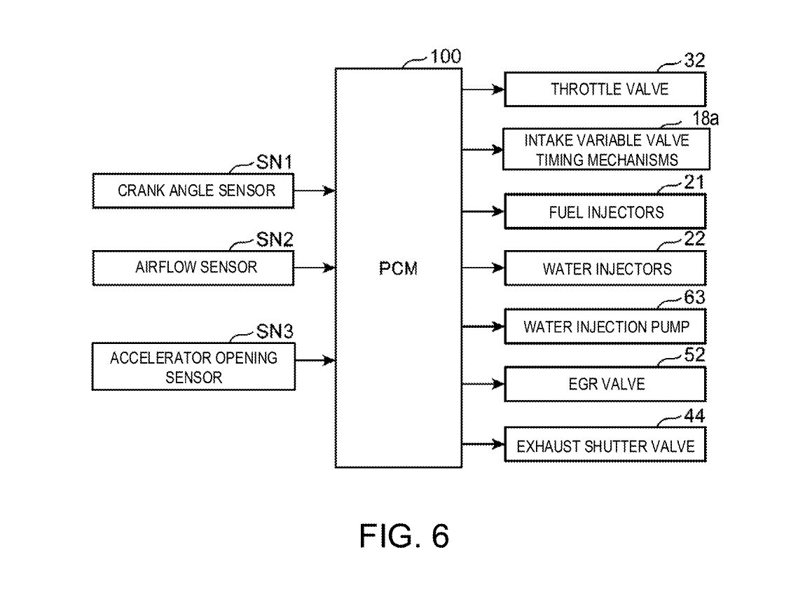

Each intake valve 18 is opened and closed by an intake valve timing mechanism. The intake valve timing mechanism is provided with intake variable valve timing mechanisms 18a (see FIG. 6) capable of changing open and close timings of the intake valves 18, and the open and close timings of the intake valves 18 are changed according to an operation condition, etc.

Further, fuel injectors 21 for injecting the fuel into the combustion chambers 6 and the water injectors 22 for injecting the supercritical water into the combustion chambers 6, respectively, are attached to the cylinder head 4. As illustrated in FIG. 4, the fuel injector 21 and the water injector 22 for the same combustion chamber 6 are arranged adjacent to each other so that tip parts (end parts on the combustion chamber 6 side) of the injectors are located near a center axis of a corresponding cylinder 2 and oriented toward a substantially center portion of the cavity 10.

Note that in this embodiment, a premixed charge compression self-ignition combustion is performed, in which the fuel and air are premixed to form the mixture gas and the mixture gas is caused to self-ignite near the TDC on compression stroke (CTDC) throughout all operating ranges of the engine body. Accordingly, in the example of FIG. 4, ignition plugs for igniting the mixture gas within the combustion chambers 6 are not provided to the engine body 1; however, in a case where an additional ignition power is required for suitable combustion of the mixture gas in a cold start etc., the ignition plugs may suitably be provided to the engine body 1.

Each water injector 22 injects the supercritical water (hereinafter, may simply be referred to as the “water” unless otherwise defined) sent from the water injection pump 63 into the combustion chamber 6, as described above. The water injector 22 has an injection port at its tip part, and a water injection amount is adjusted by changing an open period of the injection port. As the water injector 22, for example, an injector for injecting fuel into the cylinder 2, which is used in conventional engines, may be applied, and a description of a specific structure thereof is omitted. Note that the water injector 22 injects the supercritical water into the combustion chamber 6 at about 20 MPa, for example.

As described above, the water injector 22 is arranged so that the tip part thereof is located near the center axis of the cylinder 2 and oriented toward the substantially center portion of the cavity 10. Accordingly, the supercritical water is injected from the tip part of the water injector 22 toward the crown surface 5a.

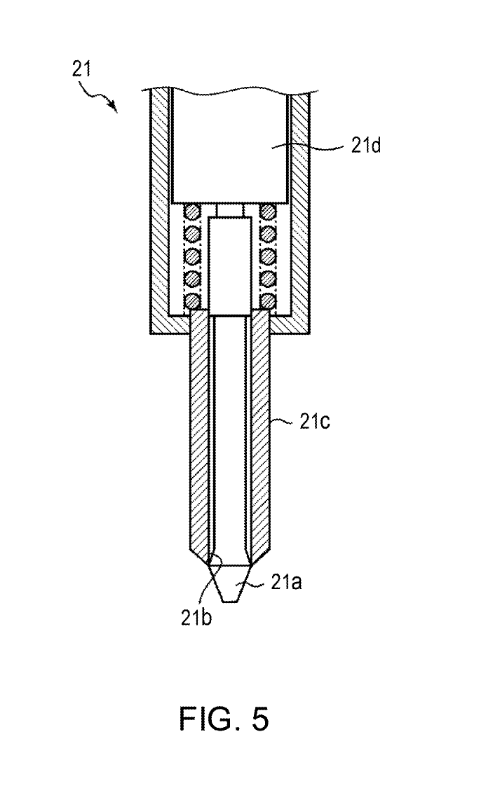

Each fuel injector 21 injects the fuel sent from a fuel pump (disposed out of the range of the drawings) into the combustion chamber 6. In this embodiment, the fuel injector 21 is an outward opening valve type. The structure of the fuel injector 21 is briefly described by using FIG. 5 which is a schematic cross-sectional view of the fuel injector 21. As illustrated in FIG. 5, the fuel injector 21 has a fuel tube 21c formed with a nozzle port 21b at a tip part thereof, and an outward opening type valve 21a disposed inside of the fuel tube 21c and for opening and closing the nozzle port 21b. The outward opening type valve 21a is connected with a piezo element 21d for deforming according to voltage applied thereto, and positionally shifts between an opening position and a closing position according to the deformation of the piezo element 21d. At the opening position, the outward opening type valve 21a protrudes from the nozzle port 21b to the tip side to open the nozzle port 21b. At the closing position, the outward opening type valve 21a closes the nozzle port 21b.

### (3) Control System

### (3-1) System Configuration

FIG. 6 is a block diagram illustrating a control system of the engine. As illustrated in FIG. 6, the engine system of this embodiment is controlled by a Powertrain Control Module (PCM, may be referred to as the controller) 100 as a whole. The PCM 100 is, as is well-known, comprised of a microprocessor including a CPU, a ROM, and a RAM.

The PCM 100 is electrically connected with various sensors for detecting an operating state of the engine.

For example, the cylinder block 3 is provided with a crank angle sensor SN1 for detecting a rotational angle and speed of a crankshaft, in other words, an engine speed. Further, an airflow sensor SN2 for detecting an air amount (fresh air amount) to be sucked into the cylinders 2 through the air cleaner 31 is provided in the intake passage 30, between the air cleaner 31 and the throttle valve 32. Moreover, an accelerator opening sensor SN3 for detecting a position of an accelerator pedal (accelerator opening) which is disposed out of the range of the drawings and controlled by a driver of the vehicle is provided to the vehicle.

The PCM 100 controls respective parts of the engine while performing various determinations, operations etc. based on input signals from the various sensors (parameters). Specifically, the PCM 100 is electrically connected with the fuel injectors 21, the water injectors 22, the throttle valve 32, the exhaust shutter valve 44, the EGR valve 52, the water injection pump 63, etc., and outputs control signals to these components based on results of the operations, etc.

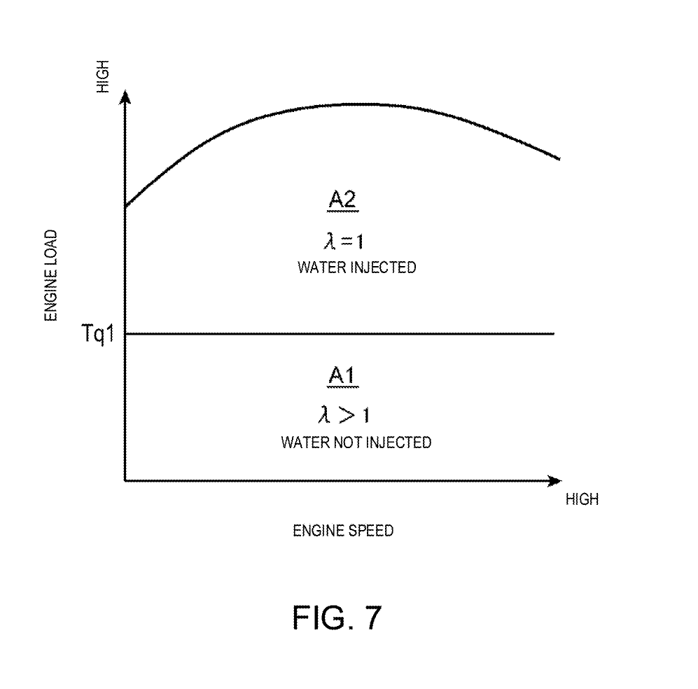

FIG. 7 is a control map of which a horizontal axis indicates the engine speed and a vertical axis indicates an engine load. In this embodiment, a low engine load range A1 where the engine load is a predetermined reference load Tq1 or below, and a high engine load range A2 (water injecting range) where the engine load is higher than the reference load Tq1 are set as control ranges. Hereinafter, contents of the control in the respective ranges A1 and A2 are described.

Here, the PCM 100 includes an operating range determining module for receiving the parameters (input signals) and determining whether a current operating range of the engine body is within the high engine load range A2. Note that the number of the parameters is not limited, as long as it includes a parameter obtained based on the accelerator opening.

### (3-2) Low Engine Load Range

Within the low engine load range A1, a requested engine torque is low, and thus, an effective compression ratio may be set small. Therefore, within the low engine load range A1, the effective compression ratio is set to a low value so as to reduce a pumping loss and increase energy efficiency. For example, the effective compression ratio is reduced to be lower than 15:1. Specifically, each intake valve 18 is closed at a comparatively retarded timing on a retarding side of the BDC on intake stroke by the intake variable valve timing mechanism 18a, and thus, the effective compression ratio is reduced.

Within the low engine load range A1, since a heat generation amount of the mixture gas is small and a combustion temperature is comparatively low, an amount of NOR (so-called Raw NOR) produced when the combustion becomes low. Thus, within this range A1, there is no need to purify NOR by the three-way catalyst 41, and an air-fuel ratio is not required to be a theoretical air-fuel ratio at which the NOR can be purified by the three-way catalyst. Therefore, within the low engine load range A1, the air-fuel ratio of the mixture gas is set to be lean, in other words, an air excess ratio λ>1, so as to improve fuel consumption.

Within the low engine load range A1, the EGR gas is recirculated into the cylinder 2. Specifically, within the low engine load range A1, the EGR valve 52 is opened, and a portion of the exhaust gas inside the exhaust passage 40 is recirculated to the intake passage 30, as the EGR gas. Moreover, within an engine operating range where the engine load is extremely low and pressure inside the exhaust passage 40, in other words, pressure on the upstream side of the EGR passage 51, is low, the opening of the exhaust shutter valve 44 is narrowed and the EGR gas recirculation is stimulated.

In this embodiment, within the low engine load range A1, the EGR gas is recirculated so that a G/F which is a ratio of a total gas weight within the combustion chamber 6 to a fuel amount becomes 35 or above. Further, an EGR ratio (a ratio of a weight of the EGR gas to a weight of all substances inside the cylinder 2) is increased as the engine load becomes higher.

Within the low engine load range A1, the supercritical water injection into the combustion chamber 6 by the water injector 22 is stopped. Accordingly, the drive of the water injection pump 63 is stopped.

Further within the low engine load range A1, in a latter half of the compression stroke (between 90° CA before the CTDC and the CTDC), all the fuel for one combustion cycle is injected into the combustion chamber 6 by the fuel injector 21. For example, all the fuel is injected into the combustion chamber 6 near 30° CA before the CTDC.

### (3-3) High Engine Load Range

Within the high engine load range A2, the effective compression ratio is set larger than that within the low engine load range A1 to secure sufficient engine torque. In this embodiment, the effective compression ratio is set to be 15:1 or above within the high engine load range A2. Specifically, the close timing of each intake valve 18 is more advanced than that within the low engine load range A1 by the intake variable valve timing mechanism 18a, and thus, the effective compression ratio is set larger than that within the low engine load range A1.

Within the high engine load range A2, the air-fuel ratio is set to be the theoretical air-fuel ratio so that the NOₓ can be purified by the three-way catalyst. In other words, the air excess ratio λ is 1. Further, within the high engine load range A2, the EGR valve 52 is closed to stop the EGR gas recirculation, and the G/F is set to a value lower than 35.

Here, within the high engine load range A2, since the engine load is high and the amount of fuel injected into the combustion chamber 6 and a heat generation amount thereof are large, a temperature within the combustion chamber 6 becomes high. Particularly in this embodiment, the temperature within the combustion chamber 6 becomes even higher due to the high effective compression ratio. Therefore, if the combustion starts in a state where the fuel is not sufficiently mixed with air, in other words, a state where the mixture gas is not homogeneous within the combustion chamber 6 (a state where an air-fuel ratio of the mixture gas is uneven), production of smoke increases. Further, within the high engine load range A2, since the temperature within the combustion chamber 6 is high, if the combustion starts before the CTDC, an absolute value of an in-cylinder pressure (the pressure within the combustion chamber 6) and an increased rate of the in-cylinder pressure become extremely high and combustion noise easily becomes loud.

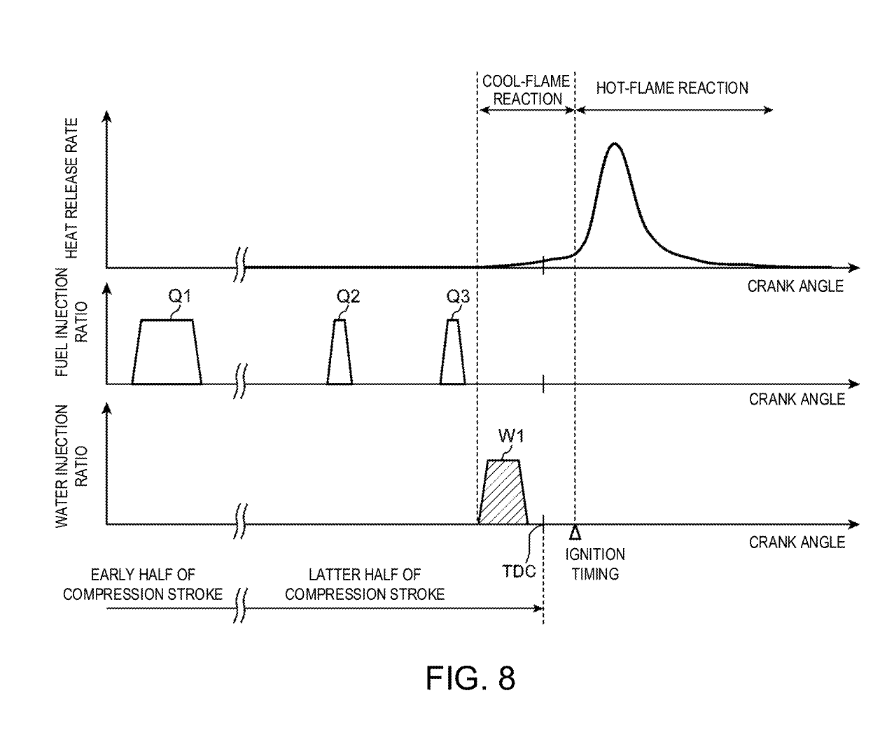

Therefore, within the high engine load range A2, fuel injections as illustrated in FIG. 8 are performed so that the combustion starts in a state where the mixture gas within the combustion chamber 6 is homogenized more, and further the combustion starts on a retarding side of the CTDC, in other words, while the piston 5 descends and the in-cylinder pressure decreases. FIG. 8 illustrates one example of a heat release rate, a fuel injection ratio, and a water injection ratio, respectively, within the high engine load range A2.

As illustrated in FIG. 8, within the high engine load range A2, a first injection Q1 in which a comparatively large amount of fuel is injected in an early half of the compression stroke (between the BDC on the intake stroke and 90° CA before the CTDC) is performed, a second injection Q2 in which a portion of the rest of the fuel is injected in the latter half of the compression stroke is performed, and then a third injection Q3 in which the rest of the fuel is injected at a timing slightly on the advancing side of the CTDC but on the retarding side of the second injection Q2 is performed.

The first injection Q1 is for homogenizing the mixture gas. In other words, by performing the first injection Q1 to inject the large amount of fuel in the early half of the compression stroke, the mixture gas within the combustion chamber 6 near the CTDC, specifically, before the combustion starts, is homogenized. The first injection Q1 starts, for example, near 150° CA before the CTDC.

The third injection Q3 is for retarding the self-ignition of the mixture gas even more. By performing the third injection Q3 at the timing slightly on the advancing side of the CTDC, the homogeneous mixture gas generated by the first injection Q1 self-ignites after the CTDC. The third injection Q3 starts, for example, near 15° CA before the CTDC.

The second injection Q2 is for increasing combustion stability. Specifically, if the rest of the fuel is all injected at the comparatively retarded timing which is near the CTDC by the third injection Q3, as the piston 5 descends, the temperature within the combustion chamber 6 may decrease to be below a combustible temperature before the combustion starts, and as a result, a misfire may occur. Therefore, in this embodiment, the second injection Q2 is performed before the third injection Q3 so as to keep the temperature within the combustion chamber 6 at the combustible temperature or above even after the CTDC. The second injection Q2 is performed near 30° CA before the CTDC, for example.

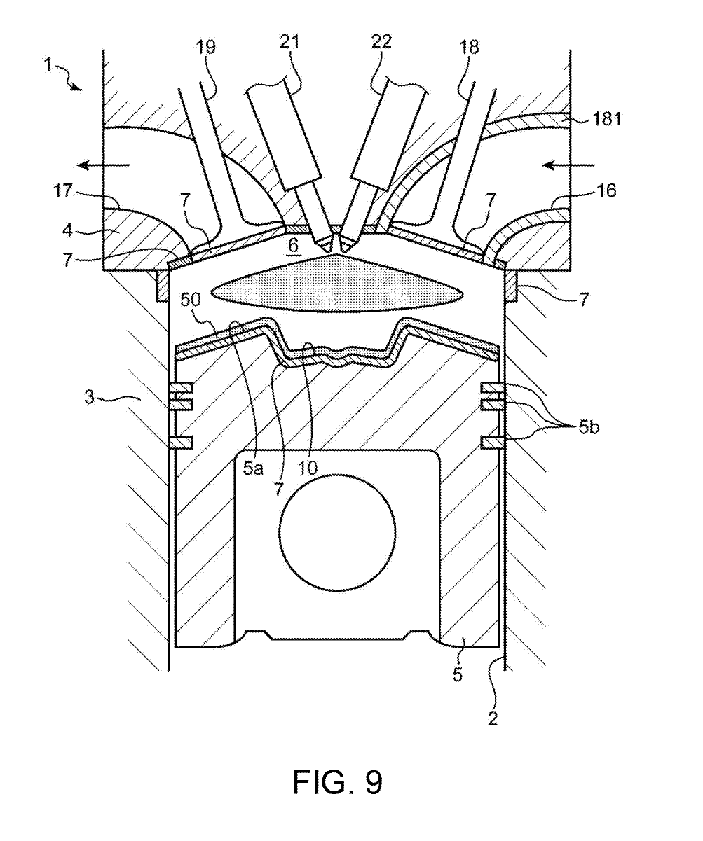

Further, within the high engine load range A2, the supercritical water is injected into the combustion chamber 6 by the water injector 22 so that a layer of supercritical water is formed on one of the wall surfaces of the combustion chamber 6 (see FIG. 9). Specifically, within the high engine load range A2, since the temperature within the combustion chamber 6 increases as described above, the cooling loss becomes high. Therefore, in this embodiment, within the high engine load range A2, the one of the wall surfaces of the combustion chamber 6 is formed with the supercritical water layer to function as the heat insulating layer 50. Specifically, the one of the wall surfaces of the combustion chamber 6 is coated with the heat insulating layer 50 on a surface of the heat insulating material 7.

Specifically, as illustrated in FIG. 8, a water injection W1 is performed at a timing that is between the latter half of the compression stroke and an early half of expansion stroke (between the CTDC and 90° CA after the CTDC), after the third injection Q3 is completed, and before the mixture gas ignites within the combustion chamber 6. In this embodiment, as illustrated in FIG. 8, the water injection W1 is performed before the CTDC.

As described above, the supercritical water is injected by the water injector 22 toward the piston crown surface 5a. Therefore, as illustrated in FIG. 9, within the high engine load range A2, by performing the water injection W1, the supercritical water is attached to the piston crown surface 5a to form the heat insulating layer 50. Particularly in this embodiment, since the water injection W1 is performed before the CTDC and while the piston 5 elevates, the supercritical water can be attached to the piston crown surface 5a more reliably. Note that a stippled area in FIG. 9 schematically indicates the state of the water injection W1.

Here, it may be considered to inject the water in the normal liquid phase as the substance to form the heat insulating layer 50, instead of the supercritical water (or subcritical water). However, the water in the normal liquid phase becomes water vapor (i.e., water in the gas phase) when injected into the combustion chamber 6 at a high temperature. Further, as described above, the water vapor has a low density. Therefore, even if the heat insulating layer is formed by injecting the water in the normal liquid phase, a weight (number of molecules) of water in the heat insulating layer is low and the heat insulating effect is low. Moreover, the water in the normal liquid phase requires latent heat to become water vapor as described above. Thus, in the case of injecting the water in the normal liquid phase, the temperature of the mixture gas decreases due to the water vaporization, and thermal efficiency degrades.

Therefore, in this embodiment, as described above, the supercritical water which has a high density and does not require latent heat is injected into the combustion chamber 6, and the supercritical water is injected into the combustion chamber 6, and this supercritical water injection is performed when the temperature and pressure of the combustion chamber 6 are high, which is between the latter half of the compression stroke and the early half of the expansion stroke, so that the injected water remains before the mixture gas ignition in the state of supercritical water. Further, as described above, the heat insulating layer 50 is formed on the wall surface of the combustion chamber 6 in the state where the mixture gas within the combustion chamber 6 is homogeneous, before the mixture gas ignition.

Note that here, an ignition timing, i.e., a timing at which the mixture gas ignites, is a timing at which the heat release rate sharply rises as illustrated in FIG. 8. Specifically, as illustrated in FIG. 8, when the temperature and pressure of the mixture gas of the fuel and air reach predetermined values, first a reaction occurs, which is a low-temperature heat release reaction (cool-flame reaction) accompanying a slight heat generation to the extent that the cooling loss, etc. does not occur, and the heat release rate gradually increases or first gradually increases and then drops, and then a reaction accompanying a large heat generation and hot flame (hot-flame reaction) occurs. Here, the timing at which this hot-flame reaction starts is referred to as the ignition timing. Note that the hot-flame reaction is known to occur when the temperature of the mixture gas becomes about 1,500 K or above. Therefore, a timing at which the temperature of the mixture gas reaches or exceeds 1,500 K may be the ignition timing.

### (4) Effects

As described above, in this embodiment, within the high engine load range A2, since a portion of the fuel is injected in the early half of the compression stroke to homogenize the mixture gas within the combustion chamber 6 before the ignition, and the supercritical water is injected into the combustion chamber 6 to form the heat insulating layer 50 on the wall surface of the combustion chamber 6, the cooling loss can be reduced to improve the fuel consumption while reducing the production of smoke. Such a control is performed particularly within an operating range where the combustion temperature becomes high, smoke is easily produced, and the cooling loss easily becomes high, which is within the range A2 where the engine load is high and the effective compression ratio is 15:1 or above, and the increase of the smoke production can effectively be reduced and the cooling loss can effectively be reduced.

### (5) Modification of First Embodiment

In this embodiment, the case where the first injection Q1 for the homogenization is performed in the early half of the compression stroke is described; however, the first injection Q1 may be performed on the intake stroke. Also in this case, the fuel is sufficiently mixed with air before the ignition of the mixture gas and the mixture gas before the ignition can be homogenized.

Further, the injection pattern of the fuel is arbitrary as long as at least a portion of the fuel is injected into the combustion chamber 6 between the intake stroke and the early half of the compression stroke, for example, it may be such that only the first injection Q1 is performed.

### (6) Second Embodiment

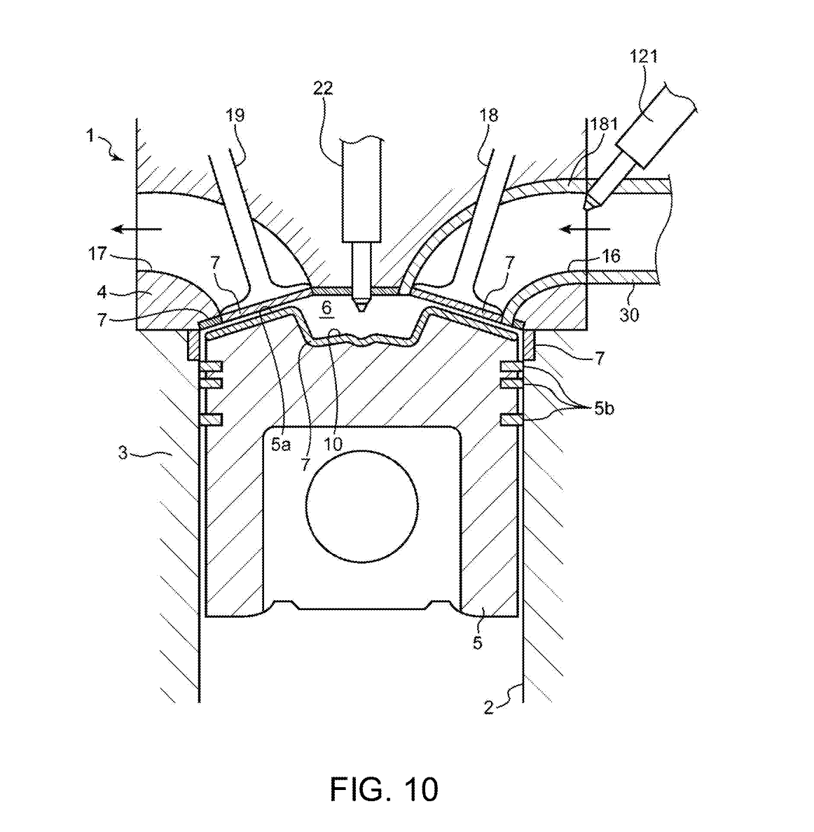

In the first embodiment, the case where the engine body 1 is a direct-injection engine and the fuel is directly injected into the combustion chamber 6 is described; however, a port injection type engine may be used as the engine body 1. Specifically, FIG. 10 is a cross-sectional view schematically illustrating an engine body according to a second embodiment of the present invention. As illustrated in FIG. 10, a fuel supplier 121 may be attached near a connecting part of the intake passage 30 with the intake ports 16 so as to supply the fuel to the intake ports 16 via the intake passage 30. Alternatively, a configuration in which the fuel is directly supplied to each intake port 16 to flow the fuel into the combustion chamber 6 from the intake port 16 along with air may be adopted.

Also in this case, the mixture gas before the ignition is homogenized. Therefore, similar to the first embodiment, by forming the heat insulating layer 50 with one of the supercritical water and the subcritical water, the cooling loss can be reduced to improve the fuel consumption while reducing the production of smoke.

Note that, in the second embodiment, configurations other than the structure and control regarding the fuel supply into the combustion chamber 6 may be similar to the first embodiment.

### (7) Modifications

In the first and second embodiments, the case where the control in which the heat insulating layers are formed by the supercritical water (or subcritical water) on the wall surface of the combustion chamber 6 while homogenizing the mixture gas within the combustion chamber 6 before the ignition is performed only within the high engine load range A2 is described; however, such a control may be performed within the low engine load range A1. Further, the effective compression ratio of the operating range where the heat insulating layer 50 is formed by the supercritical water (the high engine load range A2 in the first and second embodiments) may be below 15:1.

Note that when the engine load is high or the effective compression ratio is large, since the combustion temperature becomes high, the smoke production especially easily increases and the cooling loss easily becomes high. Therefore, even in the case where the heat insulating layer is formed by the supercritical water only within the operating range where the engine load is high or the effective compression ratio is 15:1 or above, significant effects can be obtained.

Further, in the first and second embodiments, in the case of providing the exhaust heat recovery device 60 to generate the supercritical water by using the thermal energy of the exhaust gas, within the low engine load range where the engine load is low or the operating range where the effective compression ratio is small, since the combustion temperature is low and the temperature of the exhaust gas is low, a required amount of the supercritical water may not be generated. Moreover, in a case of compensating for a lack of energy by, for example, a heater provided separately, the energy efficiency degrades. Therefore, in this case, the supercritical water is preferably injected only within the operating range where the engine load is high or the effective compression ratio is large, and the temperature of the exhaust gas is high.

Further, the supercritical water may be generated by using, for example, a heater provided separately as described above, and omitting the exhaust heat recovery device 60. However, by using the exhaust heat recovery device 60, a suitable length of ignition delay time can be secured while increasing the energy efficiency.

Further, the heat insulating materials 7 may be omitted. However, by providing the heat insulating materials 7, the cooling loss can be reduced more effectively. Moreover, since the temperature of the exhaust gas increases by providing the heat insulating materials 7, the supercritical water or the subcritical water can easily be generated in the case of using the exhaust heat recovery device 60. Moreover, even within the operating range where the engine load is low or the operating range where the effective compression ratio is small, the injection of the supercritical water etc. becomes possible without degrading the energy efficiency, and the cooling loss can be reduced also within these ranges.

Further, in the first and second embodiments, the case where the water injection is performed before the CTDC is described; however, the water injection may be performed after the CTDC (the early half of the expansion stroke).

Further, in the first and second embodiments, the case where the supercritical water is injected into the combustion chamber 6 as water is described; however, as described above, subcritical water which has properties similar to the supercritical water may be injected into the combustion chamber 6, instead of the supercritical water. Also in this case, since the density is higher than normal water and a required latent heat is extremely low, the ignition delay time can be extended.

Further, the combustion mode is not limited to the self-ignition combustion, and a mode in which the mixture gas is ignited by an ignition plug to start the combustion may be adopted. Moreover, the fuel may not include gasoline.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### LIST OF REFERENCE CHARACTERS

1 Engine Body

2 Cylinder

5 Piston

5a Piston Crown Surface

7 Heat Insulating Material

21 Fuel Injector

22 Water Injector

50 Heat Insulating Layer

60 Exhaust Heat Recovery Device

100 PCM (Controller)

121 Fuel Supplier

What is claimed is:

1. A control apparatus of an engine including an engine body and a cylinder into which a piston is reciprocatably fitted, comprising:
a fuel injector for injecting fuel into the cylinder;
a water injector for injecting one of supercritical water and subcritical water into the cylinder; and
a controller for controlling various parts of the engine, the various parts including the fuel injector and the water injector,
wherein the water injector is attached to a predetermined position of the engine body to be capable of injecting the one of the supercritical water and the subcritical water toward a crown surface of the piston,
wherein the controller includes an operating range determining module for receiving at least a parameter that varies based on an accelerator opening, and determining whether a current operating range of the engine body is within a water injection range set as at least one of operating ranges of the engine body, and
wherein when the current operating range of the engine body is determined to be within the water injection range by the operating range determining module, the controller outputs a control signal to the fuel injector to inject at least a portion of the fuel into the cylinder at one of an intake stroke and in an early half of compression stroke, and the controller outputs a control signal to the water injector to inject the one of the supercritical water and the subcritical water toward the crown surface of the piston in a period between a latter half of the compression stroke and an early half of expansion stroke, the period being after the fuel injection is completed by the fuel injector and before a mixture gas containing the fuel and air is ignited inside the cylinder.

2. The control apparatus of claim 1, wherein the water injection range is a range where a load of the engine is a predetermined reference load or above.

3. The control apparatus of claim 2, wherein a geometric compression ratio of the engine body is set to be between 18:1 and 35:1, and
wherein an effective compression ratio of the engine body within the water injection range is set to be between 15:1 and 30:1.

4. The control apparatus of claim 3, further comprising a water processing device for generating the one of the supercritical water and the subcritical water, the water processing device including:
a condenser for condensing water vapor contained within exhaust gas discharged from the engine body; and
a heater and compressor for increasing the condensed water vapor in temperature and pressure by supplying thermal energy of the exhaust gas to the condensed water vapor.

5. The control apparatus of claim 2, further comprising a water processing device for generating the one of the supercritical water and the subcritical water, the water processing device including:
a condenser for condensing water vapor contained within exhaust gas discharged from the engine body; and
a heater and compressor for increasing the condensed water vapor in temperature and pressure by supplying thermal energy of the exhaust gas to the condensed water vapor.

6. The control apparatus of claim 1, wherein a geometric compression ratio of the engine body is set to be between 18:1 and 35:1, and
wherein an effective compression ratio of the engine body within the water injection range is set to be between 15:1 and 30:1.

7. The control apparatus of claim 6, further comprising a water processing device for generating the one of the supercritical water and the subcritical water, the water processing device including:
a condenser for condensing water vapor contained within exhaust gas discharged from the engine body; and
a heater and compressor for increasing the condensed water vapor in temperature and pressure by supplying thermal energy of the exhaust gas to the condensed water vapor.

8. The control apparatus of claim 1, further comprising a water processing device for generating the one of the supercritical water and the subcritical water, the water processing device including:
a condenser for condensing water vapor contained within exhaust gas discharged from the engine body; and
a heater and compressor for increasing the condensed water vapor in temperature and pressure by supplying thermal energy of the exhaust gas to the condensed water vapor.

9. A control apparatus of an engine including an engine body, a cylinder into which a piston is reciprocatably fitted, and an intake port for introducing air into the cylinder, comprising:
a fuel supplier for injecting fuel into the intake port;
a water injector provided to the cylinder and for injecting one of supercritical water and subcritical water into the cylinder; and
a controller for controlling various parts of the engine, the various parts including the fuel supplier and the water injector,
wherein the water injector is attached to a predetermined position of the engine body to be capable of injecting the one of the supercritical water and the subcritical water toward a crown surface of the piston,
wherein the controller includes an operating range determining module for receiving at least a parameter that varies based on an accelerator opening, and determining whether a current operating range of the engine body is within a water injection range set as at least one of operating ranges of the engine body, and
wherein when the current operating range of the engine body is determined to be within the water injection range by the operating range determining module, the controller outputs a control signal to the water injector to inject the one of the supercritical water and the subcritical water toward the crown surface of the piston in a period between a latter half of compression stroke and an early half of expansion stroke, the period being before a mixture gas containing air and the fuel that is introduced into the cylinder through the intake port by the fuel supplier is ignited.

10. The control apparatus of claim 9, wherein the water injection range is a range where a load of the engine is a predetermined reference load or above.

11. The control apparatus of claim 10, wherein a geometric compression ratio of the engine body is set to be between 18:1 and 35:1, and
wherein an effective compression ratio of the engine body within the water injection range is set to be between 15:1 and 30:1.

12. The control apparatus of claim 11, further comprising a water processing device for generating the one of the supercritical water and the subcritical water, the water processing device including:
a condenser for condensing water vapor contained within exhaust gas discharged from the engine body; and
a heater and compressor for increasing the condensed water vapor in temperature and pressure by supplying thermal energy of the exhaust gas to the condensed water vapor.

13. The control apparatus of claim 10, further comprising a water processing device for generating the one of the supercritical water and the subcritical water, the water processing device including:
a condenser for condensing water vapor contained within exhaust gas discharged from the engine body; and
a heater and compressor for increasing the condensed water vapor in temperature and pressure by supplying thermal energy of the exhaust gas to the condensed water vapor.

14. The control apparatus of claim 9, wherein a geometric compression ratio of the engine body is set to be between 18:1 and 35:1, and
wherein an effective compression ratio of the engine body within the water injection range is set to be between 15:1 and 30:1.

15. The control apparatus of claim 14, further comprising a water processing device for generating the one of the supercritical water and the subcritical water, the water processing device including:
a condenser for condensing water vapor contained within exhaust gas discharged from the engine body; and
a heater and compressor for increasing the condensed water vapor in temperature and pressure by supplying thermal energy of the exhaust gas to the condensed water vapor.

16. The control apparatus of claim 9, further comprising a water processing device for generating the one of the supercritical water and the subcritical water, the water processing device including:
a condenser for condensing water vapor contained within exhaust gas discharged from the engine body; and
a heater and compressor for increasing the condensed water vapor in temperature and pressure by supplying thermal energy of the exhaust gas to the condensed water vapor.
